(19) United States
(12) Patent Application Publication
(10) Pub. No.: US 2025/0257827 A1
(43) Pub. Date: Aug. 14, 2025

(54) Bell and Spigot and Method of Making Same

(71) Applicant: Springseal, Inc., Ravenna, OH (US)

(72) Inventor: Mark Knapp, Ravenna, OH (US)

(21) Appl. No.: 19/045,846

(22) Filed: Feb. 5, 2025

Related U.S. Application Data
(60) Provisional application No. 63/552,385, filed on Feb. 12, 2024.

(51) Int. Cl. F16L 25/00; F16L 11/15

(52) U.S. Cl. CPC F16L 25/0054; F16L 11/15

(57) ABSTRACT

A corrugated pipe is described herein. The corrugated pipe includes a spigot having a leading face and a trailing end, the trailing end coupled to a pipe body. The spigot extends a spigot distance from the leading face to the trailing end. The pipe includes a liner defining a fluid flow path. The spigot further includes first and second gasket corrugations that are a corrugation length from the front face to a valley of a corrugation adjacent to the second gasket corrugation, the corrugation length less than half of the spigot length. The spigot further includes vent openings defined within the leading face, first and second sidewalls of first and second valleys of the first and second gasket corrugations, respectively, the vent openings extending at least one of transverse or parallel to the fluid flow path.

### CROSS REFERENCE TO RELATED APPLICATION

The present application is a non-provisional application that claims priority under 35 U.S.C. § 119(e) to co-pending U.S. Provisional Application Ser. No. 63/552,385 entitled BELL AND SPIGOT AND METHOD OF MAKING SAME that was filed on Feb. 12, 2024 with the United States Patent Office, the present application claims priority to said provisional application which is incorporated by reference in its entirety herein for all purposes.

### TECHNICAL FIELD

The present disclosure relates to a bell and spigot and method of making same, specifically, a spigot for forming a fluid-tight connection with a bell under high pressure such that a superior fluid sealed assembly is created between the gasket, the mating pipe, and adjoining pipe.

### BACKGROUND

For the transport of fluids that includes both liquids and gases, it is desirable to form a fluid-tight sealed connection when joining two or more pipe sections together. Numerous applications exist for transporting drain or storm, potable, or waste water using pipe sections fabricated from thermoplastic materials such as polyethylene, polypropylene, polyvinyl chloride (PVC), high density polyethylene (HDPE), and the like.

As illustrated in FIGS. 1A-1B, one common pipe configuration for the transport of fluids includes dual-wall corrugated piping 2, having a smooth interior wall 4, optimizing fluid flow characteristics and a corrugated outer wall 6 for enhanced strength and durability. Connecting the dual wall corrugated pipe sections is generally achieved by installing an oversized end of the first corrugated pipe 22 section referred to as a bell 20 over a spigot 18 located at the end of a second corrugated pipe 22 section. Seated in one of the many corrugated sections or annular grooves of the spigot's 18 outer diameter is typically a first or second discrete gasket 24, 26 that assists in forming a fluid-tight seal between the pipe sections. A fluid tight void area 8 is defined under first and second corrugations 14, 16 between the smooth interior wall 4 and bottom portions of the first and second corrugations.

One example of a gasket design for such application, as well as for other purposes includes U.S. Pat. No. 7,469,905 that issued Dec. 30, 2008 and assigned to SPRINGSEAL® (Streetsboro, Ohio) entitled PERMANENTLY LUBRICATED FILM GASKET AND METHOD OF MANUFACTURE (hereinafter “the '905 Patent”), which is incorporated herein by reference in its entirety. The elastomeric gasket contacts each of the pipe sections to form a sealed connection assembly between the pipe sections. The corrugations in the piping provide both strength and flexibility, allowing single continuous sections to extend in excess of one-hundred feet before connecting to a mating pipe section.

Typically, the smooth interior wall 4, especially at or near the spigot 18 and bell 20 connection, undergoes large forces from the flow of liquid through the pipes 2. When pressure of the liquid exceed 10 PSI, the smooth interior wall 4 collapses into a collapsed state 4a, as illustrated in FIG. 1B, impinging on the fluid tight void area 8 and ultimately causes failure of the bell 20 and/or spigot 18. The pressure exceeding 10 PSI additionally causes the the fist corrugation 14 to enter a partially collapsed state 16a. The first and second corrugations 14, 16 extending for first and second corrugation lengths 14a, 16a comprise the majority of the spigot 18. Typically, the first and second corrugation lengths 14a, 16a when combined comprise a length that is greater than three-fourths (¾) of a total spigot length. The location of the first and second corrugations 14, 16 relative to the overall length of the spigot 18 can cause excess cantilever action between the bell 20 and the spigot 18, which can lead to pipe failure. When the pipe fails ground water leaks into the pipe and fluid leaks out of the pipe and contaminates the ground or area surrounding the pipe sections.

### SUMMARY

One example embodiment of the present disclosure includes a corrugated pipe. The corrugated pipe includes a spigot having a leading face and a trailing end, the trailing end is coupled to a pipe body at a connection corrugation, the leading face is opposite the trailing end. The spigot has a lesser diameter than the pipe body, wherein the spigot extends a spigot distance from the leading face to the trailing end. The pipe includes a liner extending along an interior surface of the spigot and the pipe body, the liner defining a fluid flow path. The spigot further includes first and second gasket corrugations that are circumferentially positioned around the spigot. The first and second gasket corrugations are in contact with the liner. The first and second gasket corrugations are a corrugation length from the front face to a valley of a corrugation adjacent to the second gasket corrugation and opposite the first gasket corrugation, the corrugation length is at least one half of the spigot length.

Another example embodiment of the present disclosure includes a corrugated pipe. The corrugated pipe including a spigot having a leading face and a trailing end, the trailing end coupled to a pipe body at a connection corrugation, the leading face opposite the trailing end and a liner extending along an interior surface of the spigot and the pipe body, the liner defining a fluid flow path. The spigot further includes a first gasket corrugation that is circumferentially positioned around the spigot, the first gasket corrugation defining a first valley having first and second sidewalls and a first vent opening defined within the leading face, second and third vent openings defined within the first and second sidewalls of the first valley, respectively.

Yet another example embodiment of the present disclosure includes a corrugated pipe. The corrugated pipe including a spigot having a leading face and a trailing end, a first vent opening defined within the leading face, the trailing end coupled to a pipe body at a connection corrugation, the leading face opposite the trailing end, the spigot extending a spigot distance from the leading face to the trailing end, and a liner extending along an interior surface of the spigot and the pipe body, the liner defining a fluid flow path. The spigot further comprising including first and second gasket corrugations that are circumferentially positioned around the spigot, the first and second gasket corrugations spaced from the liner, the first and second gasket corrugations a corrugation length from the pipe body, the corrugation length less than half of the spigot length, the first gasket corrugation defining a first valley having first and second sidewalls, and second and third vent openings defined within the first and second sidewalls of the first valley, respectively. The spigot also including a gasket circumferentially positioned within at least one of the first and second gasket corrugations.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals refer to like parts unless described otherwise throughout the drawings and in which:

FIG. 1A is a cross-section of a top portion of a prior art pipe and gasket;

FIG. 1B is a cross-section of a top portion of a collapsed prior art pipe and gasket;

FIG. 2 is a partial sectional-side view of a spigot of a first corrugated pipe, in accordance with one example embodiment of the present disclosure;

FIG. 3 is a partial sectional-side view of a first corrugated pipe having a spigot and a gasket seated therein, in accordance with one example embodiment of the present disclosure;

FIG. 4 is a partial sectional-side view of a first corrugated pipe having a spigot and a gasket seated therein and an unmated bell end of a second corrugated pipe, in accordance with one example embodiment of the present disclosure; and

FIG. 5 is a sectional-side view of a gasket seated in a valley of a spigot of a first corrugated pipe and a bell end of a second corrugated pipe overlaying the spigot to form a fluid-tight connection between the first and second corrugated pipes, in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

The present disclosure relates to a bell and spigot and method of making same, specifically, a spigot for forming a fluid-tight connection with a bell under high pressure such that a superior fluid sealed assembly is created between the gasket, the mating pipe, and adjoining pipe.

The present disclosure relates to a multiple corrugation spigot 110 and a method of making. In the illustrated example embodiment, a first gasket corrugation 118, a second gasket corrugation 116, and a spigot corrugation 114 are annular and extend around the first corrugated pipe 112.

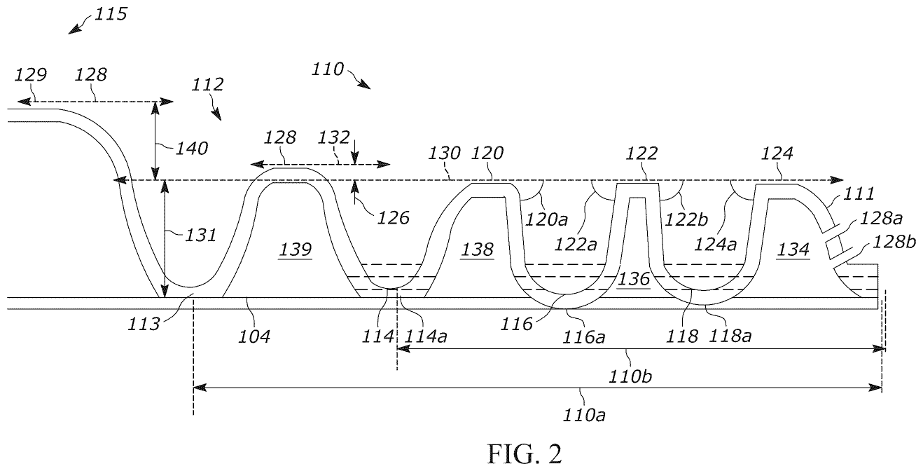

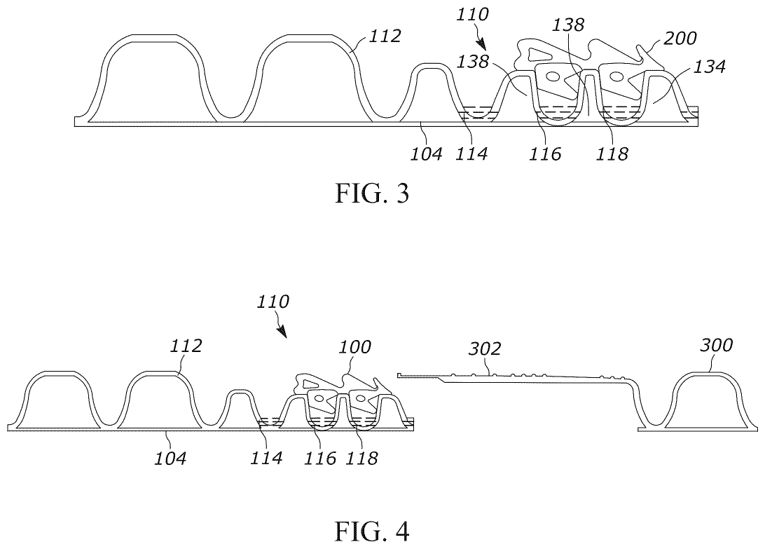

Referring to the figures, and in particular FIGS. 3-4, which are cross-sectional views of a spigot 110 of a first corrugated pipe 112 and a gasket 200 constructed in accordance with one embodiment of the disclosure forming a sealing and fluid-tight connection between the spigot 110 of the first corrugated pipe 112 and a bell 302 of a second corrugated pipe 300. The first and second corrugated pipes 112, 130 comprising at least one of polypropylene, steel, polyvinyl chloride (PVC), and high-density polyethylene (HDPE).

In this example embodiment, the spigot 110 defines first and second gasket corrugations 118, 116 respectively, and a spigot corrugation 114. The first and second gasket corrugations 118, 116, and the spigot corrugation 114 are transverse corrugations that extend circumferentially around the first corrugated pipe 112. The first and second gasket corrugations 118, 116, and the spigot corrugation 114 are defined along the spigot 110, wherein the spigot extends from a mating face 111 of the first corrugated pipe 112 to a valley of a transition corrugation 113. Stated another way, the spigot 110 has corrugations having a diameter as measured from a peak that are less the than a diameter as measured from a peak of corrugations of a pipe body 115. In another example embodiment, the spigot 110 has corrugations having a diameter as measured from a peak that are the same as the diameter as measured from the peak of corrugations of a pipe body 115.

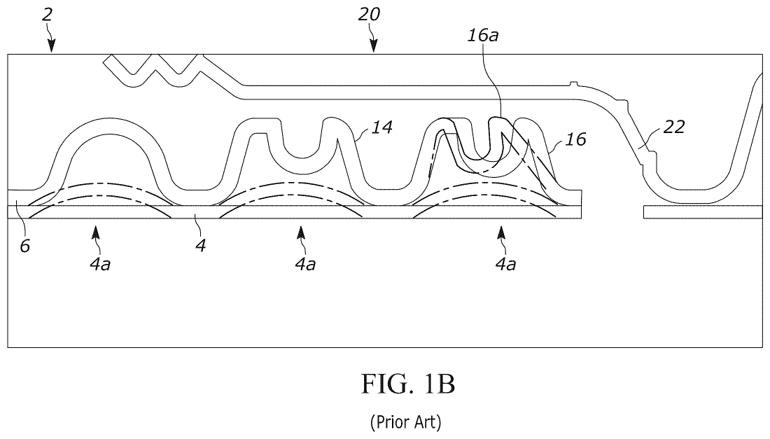

In the example embodiment of FIG. 2, the first and second gasket corrugations 118, 116 touch and rest upon the liner 104 at first and second liner interaction areas 118a, 116a. In another example embodiment of FIG. 2, the first and second gasket corrugations 118, 116 are integrally formed with the liner 104 at the first and second liner interaction areas 118a, 116a. In the example embodiment of FIG. 2, the spigot corrugation 114 are integrally formed the liner 104 at the third liner interaction area 114a. In another example embodiment of FIG. 2, the spigot corrugation 114 touches and rests upon the liner 104 at a third liner interaction area 114a. In another example embodiment, the first and second gasket corrugations 118, 116 do not touch or rest upon the liner 104, and/or the spigot corrugation 114 do not touch or rest upon the liner 104. Stated another way, in one example embodiment, the first and second gasket corrugations 118, 116 are separate from the liner 104.

In one example embodiment, a mating face 111 proceeds the first gasket corrugation 118 and extends away from the pipe body 115. It would be understood as used herein, proceeds indicates a feature is nearer the mating face 111, and succeeds indicates a features is nearer the pipe body 115. In this example embodiment, a leading void 134 is defined between the first gasket corrugation 118, the mating face 111, and the liner 104. In one example embodiment, an intermediate void 136 is defined between the first gasket corrugation 118, the second gasket corrugation 116, and the liner 104. In one example embodiment, a medial void 138 is defined between the second gasket corrugation 116, the spigot corrugation 114, and the liner 104. In one example embodiment, a trailing void 139 is defined between the spigot corrugation 114, the transition corrugation 113, and the liner 104.

A first peak 124 proceeds a valley of the first gasket corrugation 118 and succeeds the mating face 111 of the spigot 110, wherein the first peak defines a flat or planar surface. A second peak 122 proceeds the valley of the first gasket corrugation 118 and succeeds the valley of the second gasket corrugation 116, wherein the second peak defines a flat or planar surface. A third peak 120 succeeds the valley of the second gasket corrugation 116 and proceeds a valley of the spigot corrugation 114, wherein the third peak defines a flat or planar surface. In the example embodiment of FIG. 2, the first, second, and third peaks 124, 122, 120 are co-axial as illustrated by a peak axis 130. In one example embodiment, the peak axis 130 is a peak distance 131 from the liner 104. Stated another way, the first, second, and third peaks 124, 122, 120 have a common height or extend a same distance from the liner 104. A fourth peak 128 succeeds a valley of the spigot corrugation 114 and proceeds a valley of a transition corrugation 113, wherein the fourth peak defines a flat or planar surface. In this example embodiment, the fourth peak 118 extends along a spigot axis 132. In one example embodiment the spigot axis 132 is a spigot distance 126 from the peak axis 130. In one example embodiment, the spigot distance 126 is between about 1 inch to about 3 foot.

In one example embodiment, a corrugation peak 129 extends along a corrugation axis 128. In this example embodiment, the transition corrugation 113 transitions from the spigot 110 to the pipe body 115 of the first pipe 112, wherein the spigot ends at the valley of the transition peak and the corrugation peak 129. In this example embodiment, the corrugation peak 129 extends along a pipe axis 128. In one example embodiment, additional peaks of corrugations on the pipe body 115 extend along a pipe axis 128 when the pipe is on a flat surface. In one example embodiment, the is corrugation peak 129 is a pipe distance 140 from the peak axis 130. In one example embodiment, the pipe distance 140 is between about 1 inch to about 2 foot. In one example embodiment, a ratio of the pipe distance 140 to the peak distance 131 is a ratio of 1:1, 1:2, 1:4, or 1.5.

In one example embodiment, first and second sidewalls of the valley of first gasket corrugation 118 extend toward the first liner interaction area 118a at respective first and second angles 122b, 124a from the respective first and second peaks 124, 122. In one example embodiment, the first and second angles 122b, 124a are between 90° to about 50°. In another example embodiment, the first and second angles 122b, 124a are 80°.

In one example embodiment, first and second sidewalls of the valley of second gasket corrugation 116 extend toward the second liner interaction area 116a at respective first and second angles 122a, 120a from the respective second and third peaks 122, 120. In one example embodiment, the first and second angles 122a, 120a are between 90° to about 50°. In another example embodiment, the first and second angles 122a, 120a are 80°. It would be appreciated by one having ordinary skill in the art that the first and second angles 122a, 120a, 122b, 124a of the first and second gasket corrugations 118, 116 could be the same or different.

In one example embodiment, the spigot 110 has a spigot length 110a extending from the mating face 111 to the valley of the transition corrugation 113. In another example embodiment, the first and second gasket corrugations 118, 116 have a corrugation length 110b extending from the mating face 111 to the third liner interaction area 114a. In one example embodiment, the corrugation length 110b is less than two thirds (⅔) of the spigot length 110a. In another example embodiment, the corrugation length 110b is less than three-fourths (¾) of the spigot length 110a. In yet another example embodiment, the corrugation length 110b is less than one-half (½) of the spigot length 110a. The first and second gasket corrugations 118, 116 being relatively close to the mating face 111 renders stretching of the gasket 100 over the spigot 110 of the first corrugated pipe 112 into one or both of the corrugation seats (e.g., the first and second gasket corrugations 118, 116) less strenuous and results in less required stretch, and thus, less wear and tear of the gasket.

As illustrated in FIGS. 3-4, the gasket 100 is formed of a tubular configuration that is circumferentially positioned around the first and second gasket corrugations 118, 116. In one example embodiment, the gasket 100 is made one of High Density Polyethylene (“HDPE”) and rigid polypropylene plastic.

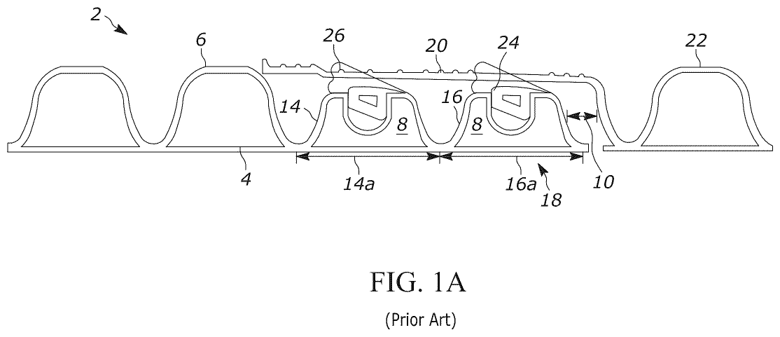

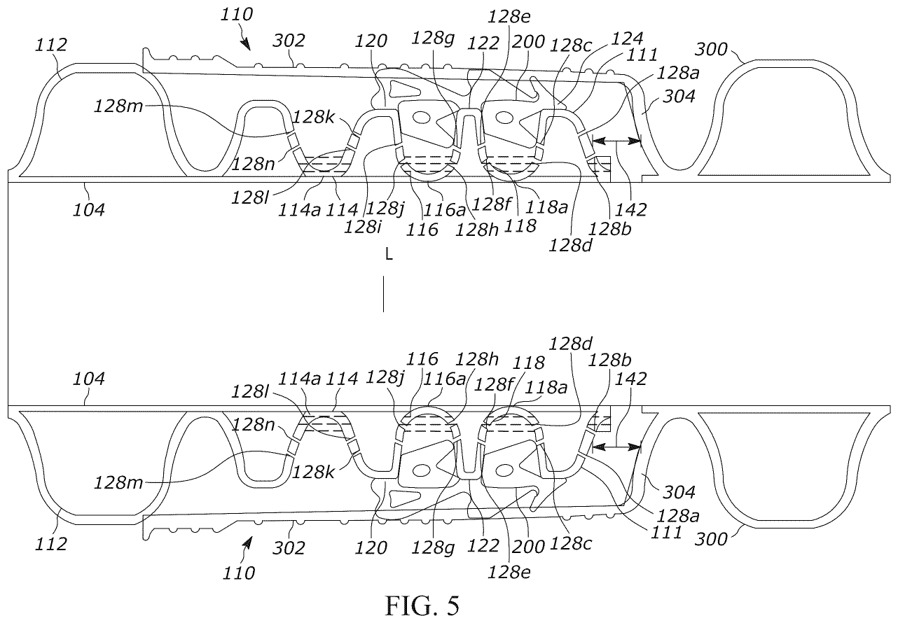

As illustrated in the example embodiment of FIGS. 2 and 5, the peak axis 130, the spigot axis 132, and/or pipe axis 128 are parallel to a central axis L of the first corrugated pipe 112. As illustrated in the example embodiment of FIG. 5, the bell 302 of the second corrugated pipe 300 is coupled to and over the spigot 110. In this example embodiment, the bell 302 interacts and rests upon the gasket 200 over the spigot 110. The gasket 200, being seated within the first and second gasket corrugations 118, 116, is relatively closer to an interaction face 304 of the second pipe 300, than if the corrugations were spaced as in the prior art FIG. 1. The interaction of the gasket 200 and the bell 302 of first corrugated pipe 112 reduces a cantilever effect felt in the prior art bell 20 and spigot of FIG. 1. In this example embodiment, the interaction face 304 is an interaction distance 142 from the mating face 111. In one example embodiment, the interaction distance 142 is between 1 to 15 inches.

In the illustrated embodiment of FIG. 5, at least one vent opening 128 is present within one of the first gasket, second gasket, and/or spigot corrugation 118, 116, 114. In one example embodiment, first and/or second vent openings 128a, 128b are defined within the mating face 111. In another example embodiment, third, fourth, fifth, and/or sixth vent openings 128c, 128d, 128e, 128f are defined within the first gasket corrugation 118 In one example embodiment, the third and/or fourth vent openings 128c, 128d are defined on a first sidewall of the valley of the first gasket corrugation 118, and the fifth and/or sixth vent openings 128e, 128f are defined on a second sidewall of the valley of the first gasket corrugation 118. In this example embodiment the first sidewall is opposite the second sidewall.

In another example embodiment, seventh, eighth, ninth, and/or tenth vent openings 128g, 128h, 128i, 128j are defined within the second gasket corrugation 116. In one example embodiment, the seventh and/or eighth fourth openings 128g, 128h are defined on a first sidewall of the valley of the second gasket corrugation 116, and the ninth and/or tenth vent openings 128i, 128j are defined on a second sidewall of the valley of the second gasket corrugation 116. In this example embodiment, the first sidewall is opposite the second sidewall.

In another example embodiment, eleventh, twelfth, thirteenth, and/or fourteenth vent openings 128k, 128l, 128m, 128n are defined within the spigot corrugation 114. In one example embodiment, the eleventh and/or twelfth vent openings 128k, 128l are defined on a first sidewall of the valley of the spigot corrugation 114, and the thirteenth, and/or fourteenth vent openings 128m, 128n are defined on a second sidewall of the valley of the spigot corrugation 114. In this example embodiment the first sidewall is opposite the second sidewall. It would be understood by one having ordinary skill in the art that each valley sidewall may have none, one, and/or two vent openings present. In one example embodiment only the first, third, fifth, seventh, ninth, eleventh, and thirteenth vent 128a, 128c, 128e, 128g, 128i, 128k, 128m openings are present. In another example embodiment, the spigot corrugation 114 lacks the eleventh, twelfth, thirteenth, and/or fourteenth vent openings 128k, 128l, 128m, 128n.

In one example embodiment, the vent openings 128a-128j are one of transverse or parallel to the central axis L. In one example embodiment, the vent openings 128a-128j define a square, circular, polygonal, rectangular, and/or oval shape. In another example embodiment, the vent openings 128a-128j have an opening radius or width. In one example embodiment, the opening radius or width is between 1 mm to about 10 mm.

In one example embodiment, the vent openings 128a-128j are formed in the liner 104 rather than in the valleys as described above. In one example embodiment, at least one of the first, third, fifth, seventh, ninth, eleventh, and thirteenth vent openings 128a, 128c, 128e, 128g, 128i, 128k, 128m are formed in the liner 104 and the openings extend into the leading void 134, the intermediate void 136, the medial void 138, and/or the trailing void 139, respectively. In one example embodiment, at least one of the second, fourth, sixth, eighth, tenth, twelfth and/or fourteenth vent opening 128b, 128d, 128f, 128h, 128j, 128l, 128n are formed in the valley sidewalls as described above, while at least one of the first, third, fifth, seventh, ninth, eleventh, and thirteenth vent openings 128a, 128c, 128e, 128g, 128i, 128k, 128m are formed in the liner 104. It is contemplated that the vent openings 128 extend through additional corrugations including corrugations that extend along a partial or a full length of the pipe 112.

Advantageously, the vent openings 128a-128j normalize pressure between the liner 104 and the interior of the first pipe 112. The vent openings 128a-128j prevent pressure from gas or liquid within the first corrugated pipe 112 from forcing the liner 104 to collapse into the leading void 134, the intermediate void 136, the medial void 138, and/or the trailing void 139. The vent openings 128a-128 allow the gas or liquid to enter into at least one of the leading void 134, the intermediate void 136, the medial void 138, and/or the trailing void 138, causing the pressure in the respective voids to be equal to the pressure within the first corrugated pipe 112. Advantageously, the equalization of pressure between the interior and exterior of the liner 104 allows for higher pressure (e.g., 15-50 PSI) to travel through the bell 302 and spigot 110 of the first and second corrugated pipe 112, 300.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 100%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A corrugated pipe comprising:
a spigot having a leading face and a trailing end, the trailing end coupled to a pipe body at a connection corrugation, the leading face opposite the trailing end, the spigot having a lesser peak diameter than the pipe body, the spigot extending a spigot distance from the leading face to the trailing end; and
a liner extending along an interior surface of the spigot and the pipe body, the liner defining a fluid flow path, the spigot further comprising:
first and second gasket corrugations that are circumferentially positioned around the spigot, the first and second gasket corrugations in contact with the liner, the first and second gasket corrugations a corrugation length from the pipe body, the corrugation length less than half of the spigot length.

2. The corrugated pipe of claim 1, wherein a gasket is circumferentially positioned within at least one of the first and second gasket corrugations.

3. The corrugated pipe of claim 1, wherein a first vent opening is defined within the leading face.

4. The corrugated pipe of claim 3, wherein the first gasket corrugation defines a first valley having first and second sidewalls, and second and third vent openings are defined within the first and second sidewalls of the first valley, respectively.

5. The corrugated pipe of claim 4, wherein the second gasket corrugation defines a second valley having first and second sidewalls, and wherein fourth and fifth vent openings are defined within the first and second sidewalls of the second valley, respectively.

6. The corrugated pipe of claim 5, wherein the first, second, third, fourth and fifth vent openings extend at least one of transverse or parallel to the fluid flow path.

7. The corrugated pipe of claim 6, wherein a leading void is defined between the first gasket corrugation, the leading face, and the liner, wherein the first vent opening and the second vent opening extend into the leading void.

8. The corrugated pipe of claim 7, wherein an intermediate void is defined between the first gasket corrugation, the second gasket, and the liner, wherein the third vent opening and the fourth vent opening extend into the intermediate void, and fluidly couple the intermediate void to the leading void when the pipe is in use.

9. The corrugated pipe of claim 1 wherein a leading void is defined between the first gasket corrugation, the leading face, and the liner, wherein one or more void openings are formed in the leading face and the first gasket corrugation and the openings extend into the leading void.

10. The corrugated pipe of claim 9, wherein an intermediate void is defined between the first gasket corrugation, the second gasket, and the liner, wherein one or more void openings are formed in the liner and the openings extend into the intermediate void.

11. A corrugated pipe defining a spigot, the corrugated pipe comprising:
a spigot having a leading face and a trailing end, the trailing end coupled to a pipe body at a connection corrugation, the leading face opposite the trailing end; and
a liner extending along an interior surface of the spigot and the pipe body, the liner defining a fluid flow path, the spigot further comprising:
a first gasket corrugation that is circumferentially positioned around the spigot, the first gasket corrugation defining a first valley having first and second sidewalls; and
a first vent opening defined within the leading face, second and third vent openings defined within the first and second sidewalls of the first valley, respectively.

12. The corrugated pipe of claim 11, comprising a second gasket corrugation adjacent to the first gasket corrugation, the second gasket corrugation is circumferentially positioned around the spigot and defines a second valley having first and second sidewalls.

13. The corrugated pipe of claim 12, wherein at least one of the first and second gasket corrugations are in contact with the liner.

14. The corrugated pipe of claim 12, wherein fourth and fifth vent openings are defined within the first and second sidewalls of the second valley, respectively, further wherein the first, second, third, fourth and fifth vent openings extend at least one of transverse or parallel to the fluid flow path.

15. The corrugated pipe of claim 11, wherein a leading void is defined between the first gasket corrugation, the leading face, and the liner, wherein the first vent opening and the second vent opening extend into the leading void.

16. The corrugated pipe of claim 11, comprising a second gasket corrugation adjacent to the first gasket corrugation, the second gasket corrugation is circumferentially positioned around the spigot and defines a second valley having first and second sidewalls, wherein an intermediate void is defined between the first gasket corrugation, the second gasket corrugation, and the liner, wherein the third vent opening and the fourth vent opening extend into the intermediate void.

17. The corrugated pipe of claim 16, wherein a third gasket corrugation is circumferentially positioned around the spigot and adjacent to the first and second gasket corrugations, the third gasket corrugation in contact with the liner, the third gasket corrugation defining a first valley having first and second sidewalls.

18. The corrugated pipe of claim 17, wherein a leading void is defined between the first gasket corrugation, the leading face, and the liner, wherein the first vent opening and the second vent opening extend into the leading void, further wherein an intermediate void is defined between the first gasket corrugation, the second gasket, and the liner, wherein the third vent opening and the fourth vent opening extend into the intermediate void, and further wherein a medial void is defined between the second gasket corrugation, the third gasket, and the liner, wherein the vent openings fluidly couple the medial, intermediate, and leading voids when the pipe is in use.

19. A corrugated pipe comprising:
a) a spigot having a leading face and a trailing end, a first vent opening defined within the leading face, the trailing end coupled to a pipe body at a connection corrugation, the leading face opposite the trailing end, the spigot extending a spigot distance from the leading face to the trailing end;
b) a liner extending along an interior surface of the spigot and the pipe body, the liner defining a fluid flow path, the spigot further comprising:
i) first and second gasket corrugations that are circumferentially positioned around the spigot, the first and second gasket corrugations spaced from the liner, the first and second gasket corrugations a corrugation length from the pipe body, the corrugation length less than half of the spigot length, the first gasket corrugation defining a first valley having first and second sidewalls, and second and third vent openings defined within the first and second sidewalls of the first valley, respectively; and
c) a gasket circumferentially positioned within at least one of the first and second gasket corrugations.

20. The corrugated pipe of claim 19, wherein the first, second, and third vent openings extend at least one of transverse or parallel to the fluid flow path.
